(19) United States
(12) Patent Application Publication
(10) Pub. No.: US 2014/0168687 A1
(43) Pub. Date: Jun. 19, 2014

(54) IMAGE FORMING APPARATUS SUPPORTING NEAR FIELD COMMUNICATION (NFC) FUNCTION AND METHOD OF PERFORMING AUTHENTICATION OF NFC DEVICE THEREOF

(71) Applicant: Samsung Electronics Co., Ltd, Suwon-si (KR)

(72) Inventors: Jin-hyung KIM, Suwon-si (KR); Dae-hyun KIM, Yongin-si (KR); Sung-joon PARK, Hwaseong-si (KR)

(73) Assignee: Samsung Electronics Co., Ltd, Suwon-si (KR)

(21) Appl. No.: 14/079,904

(22) Filed: Nov. 14, 2013

(30) Foreign Application Priority Data
Dec. 18, 2012 (KR) 10-2012-0148875

(51) Int. Cl. G06F 3/12; H04N 1/00

(52) U.S. Cl. CPC G06F 3/1287; H04N 1/00106; H04N 1/00281; H04N 1/00838
USPC 358/1.14

(57) ABSTRACT

An image forming apparatus supporting a near field communication (NFC) function and a method of performing authentication of an NFC device in the image forming apparatus is provided. The method includes receiving identification information by tagging an NFC device and determining whether the NFC device is authenticated or not, by using the received identification information.

### CROSS-REFERENCE TO RELATED APPLICATIONS

This application claims priority under 35 U.S.C. §119 from Korean Patent Application No. 10-2012-0148875, filed on Dec. 18, 2012, in the Korean Intellectual Property Office, the disclosure of which is incorporated herein in its entirety by reference.

### BACKGROUND OF THE INVENTION

1. Field of the Invention

The present general inventive concept relates to an image forming apparatus supporting a near field communication (NFC) function and a method of performing authentication of an NFC device in the image forming apparatus.

2. Description of the Related Art

Near field communication (NFC) is a contactless short-range wireless communication standard between electronic devices within a short distance of 10 cm with low power consumption by using a frequency of 13.56 MHz, and was developed by the joint work of NXP Semiconductors of Netherlands and SONY of Japan in 2002. A data transfer rate of NFC is 424 Kilobytes per second (Kbps), and NFC has excellent security due to high proximity and encryption technology. NFC forgoes a complicated pairing process for recognition of devices but allows devices to recognize one another within 1/10 second or less. In particular, NFC is a smart card type contactless wireless communication technology where radio frequency identification (RFID) technology is utilized. NFC builds upon RFID technology by allowing two-way communication, unlike typical smart cards, which only allow one-way communication. NFC has a relatively large memory storage space and offers more variety of services than basic RFID. Accordingly, commercialized electronic devices, such as smartphones and personal computers, in which NFC technology is used, have recently been released.

### SUMMARY OF THE INVENTION

Features and utilities of the present general inventive concept provide an image forming apparatus supporting a near field communication (NFC) function and a method of performing authentication of an NFC device in the image forming apparatus.

Features and utilities of the present general inventive concept also provide a computer-readable medium containing computer-readable codes as a program to execute the method on a computer.

Additional features and utilities of the present general inventive concept will be set forth in part in the description which follows and, in part, will be obvious from the description, or may be learned by practice of the general inventive concept.

Exemplary embodiments of the present general inventive concept provide an image forming apparatus supporting a near field communication (NFC) function, the image forming apparatus including an NFC module to receive identification information of a user device having the NFC function by tagging the user device, and a controlling unit to determine whether the tagged user device is an authenticated device with regard to one or more image forming operations of the image forming apparatus by using the NFC function, based on the received identification information, wherein the controlling unit controls execution of one of the image forming operations when requested by the tagged user device, when the tagged user device is determined as an authenticated device with regard to the requested image forming operation.

The image forming apparatus may further a storing unit to store a first authentication list to manage a list of one or more NFC devices with regard to which of the one or more image forming operations of the image forming apparatus is authenticated for each of the NFC devices by using the NFC function, wherein the controlling unit determines whether authentication information mapped to the received identification information exists in the stored first authentication list.

The stored first authentication list may include authentication information of each of the NFC devices, and usage quota information of the image forming operations allocated to each of the NFC devices.

The controlling unit may include an authentication managing unit to determine whether authentication information mapped to the received identification information exists in the stored authentication information, and a usage quota managing unit to control the execution of the requested image forming operation based on a usage quota allocated to the tagged user device when it is determined that the mapped authentication information exists.

The image forming apparatus may further include a wireless communication module to transmit and receive working data about the tagged user device and the requested image forming operation, wherein the controlling unit activates wireless communication between the tagged user device and the wireless communication module when it is determined that the tagged user device is an authenticated device with regard to the requested image forming operation.

The image forming apparatus may further include a network interface unit to receive a second authentication list from a server that manages registration of at least one of authentication information and usage quota information of one or more NFC devices, wherein the controlling unit controls updates of the first authentication list stored in the storing unit based on the received second authentication list.

The network interface unit may receive the second authentication list from at least one of a remote authentication dial in user service (RADIUS) server that performs authentication, authorization, and accounting of the NFC devices and an NFC reader that tags the NFC devices to manage registration of at least one of authentication information and usage quota information of the NFC devices.

The image forming apparatus may further include a user interface unit that receives an input by a user or a manager regarding registration of at least one of authentication information and usage quota information of one or more NFC devices, wherein the controlling unit controls updates of the first authentication list stored in the storing unit based on the received input.

The image forming apparatus may further include an embedded web server unit to manage registration of information, the information including at least one of authentication information and usage quota information of one or more NFC devices, wherein the controlling unit controls updates of the first authentication list stored in the storing unit based on the information registered in the embedded web server unit.

The image forming apparatus may further include a storing unit to store working data generated by the requested image forming operation requested by the tagged user device while there is no authentication information about the tagged user device, wherein the controlling unit controls completing of the requested image forming operation by using the stored working data when an operation of storing authentication information about the tagged user device in the storing unit is completed.

The identification information may include at least one of a media access control (MAC) address, an Internet protocol (IP) address, a phone number, and a personal identification number (PIN) of the user device.

The controlling unit may include at least one of a mobile printing function of printing data received from the tagged user device and a mobile scan function of transmitting data generated by a scan function of the image forming apparatus to the tagged user device.

Exemplary embodiments of the present general inventive concept provide a method of performing authentication of near field communication (NFC) devices in an image forming apparatus supporting an NFC function, the method including receiving identification information of a user device having the NFC function by tagging the user device, determining whether the tagged user device is an authenticated device with regard to one or more image forming operations of the image forming apparatus by using the NFC function, based on the received identification information, and controlling execution of one of the image forming operations when requested by the tagged user device, when it is determined that the tagged user device is an authenticated device with regard to the requested image forming operation.

The method may further include storing a first authentication list to manage a list of one or more NFC devices with regard to which of the one or more image forming operations of the image forming apparatus is authenticated for each of the NFC devices by using the NFC function, wherein the determining includes determining whether authentication information mapped to the received identification information exists in the stored first authentication list.

The stored first authentication list may include authentication information of each of the NFC devices, and a usage quota of the image forming operations allocated to each of the NFC devices.

The method may further include activating wireless communication between a wireless communication module and the tagged user device when it is determined that the tagged user device is an authenticated device with regard to the requested image forming operation.

The method may further include receiving a second authentication list from a server that manages registration of at least one of authentication information and usage quota information of one or more NFC devices via a network interface unit, and updating the stored first authentication list based on the received second authentication list.

The method may further include receiving from a user or a manager an input regarding registration of at least one of authentication information and usage quota information of one or more NFC devices via at least one of a user interface unit and an embedded web server unit, and updating the stored first authentication list stored in the storing unit based on the received input.

The method may further include storing working data generated by the requested image forming operation requested by the tagged user device while there is no authentication information about the tagged user device, wherein the controlling includes controlling completing of the requested image forming operation by using the stored working data when an operation of storing authentication information about the tagged user device in the storing unit is completed.

Exemplary embodiments of the present general inventive concept provide a non-transitory computer-readable recording medium having embodied thereon a program to execute the method described above.

Exemplary embodiments of the present general inventive concept provide an NFC module to receive identification information of an NFC user device, and a controlling unit to determine whether the NFC user device is authenticated according to the received identification information and stored identification information, and to execute an image forming operation of the image forming apparatus according to the determination of authentication and a selection from the NFC user device.

The stored identification information is stored at the image forming apparatus prior to receiving the identification information.

The stored identification information is stored at the image forming apparatus after the controlling unit controls the image forming operation to begin.

The NFC module may perform at least one of transmitting and receiving contents related to the image forming operation to and from the NFC user device.

The image forming apparatus may include a wireless communication unit to perform at least one of transmitting and receiving contents related to the image forming operation to and from the NFC user device.

Exemplary embodiments of the present general inventive concept provide a method of performing an image forming operation, the method including receiving via NFC identification information of an NFC user device, determining whether the NFC user device is authenticated according to the received identification information and stored identification information, and executing an image forming operation according to the determination of authentication and a selection from the NFC user device.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1A illustrates a near field communication (NFC) environment according to an exemplary embodiment of the present general inventive concept;

FIG. 1B illustrates an NFC environment which is similar to that of FIG. 1A, according to another exemplary embodiment of the present general inventive concept;

FIG. 1C illustrates a wireless communication environment in which an image forming apparatus and a smartphone are present, according to an exemplary embodiment of the present general inventive concept;

FIG. 2A is a graph comparing data rates and communication ranges of NFC and other wireless communication methods;

FIG. 2B is an overview of standards related to NFC technology;

FIGS. 3A and 3B are diagrams illustrating three communication modes of NFC;

FIG. 4 is a block diagram illustrating a basic hardware structure of an image forming apparatus supporting an NFC function, according to an exemplary embodiment of the present general inventive concept;

FIG. 5 illustrates an NFC tag and information which may be stored in the NFC tag installed in the image forming apparatus of FIG. 1B;

FIG. 6 is a block diagram illustrating a hardware structure of an image forming apparatus that performs authentication of NFC devices by tagging a user device, according to an exemplary embodiment of the present general inventive concept;

FIG. 7 illustrates an authentication list of NFC devices stored in a storing unit according to an exemplary embodiment of the present general inventive concept;

FIG. 8 illustrates a user interface (UI) screen to input authentication data via a user interface unit or an embedded web server unit according to an exemplary embodiment of the present general inventive concept;

FIG. 9 is a schematic view illustrating a mobile printing function and a mobile scan function which may be performed between an image forming apparatus and a user device, according to an exemplary embodiment of the present general inventive concept;

FIG. 10 illustrates a mobile printing operation performed by authenticating a user device in an image forming apparatus according to an exemplary embodiment of the present general inventive concept;

FIG. 11 illustrates a mobile scanning operation performed by authenticating a user device in an image forming apparatus according to an exemplary embodiment of the present general inventive concept;

FIG. 12 illustrates an operation in which authentication of a user device is completed after first generating print data or scan data in an image forming apparatus and then a mobile printing operation or a mobile scanning operation is performed, according to an exemplary embodiment of the present general inventive concept; and

FIG. 13 is a flowchart illustrating a method of performing authentication of a user device in an image forming apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Expressions such as “at least one of,” when preceding a list of elements, modify the entire list of elements and do not modify the individual elements of the list.

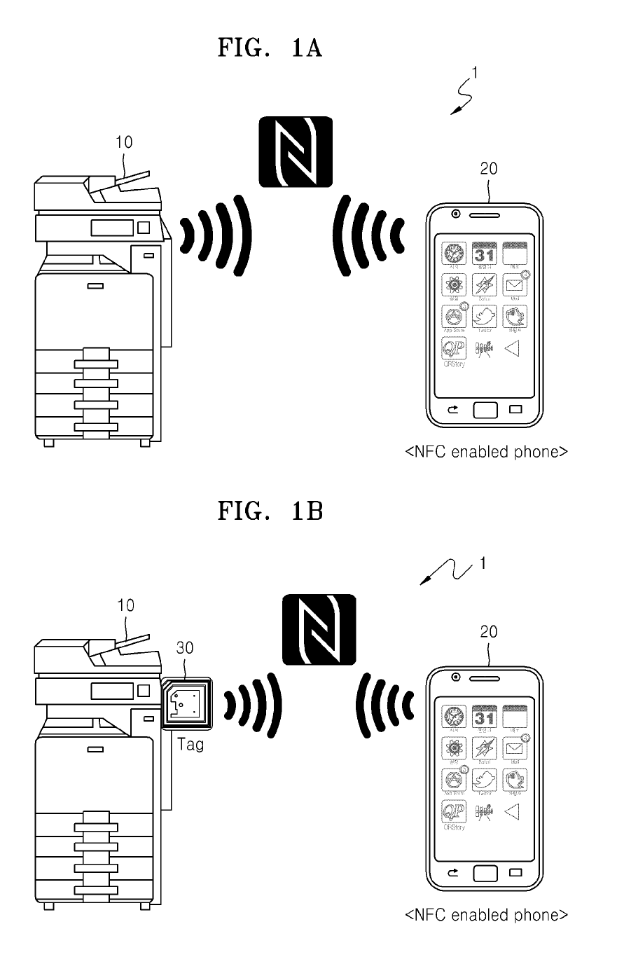

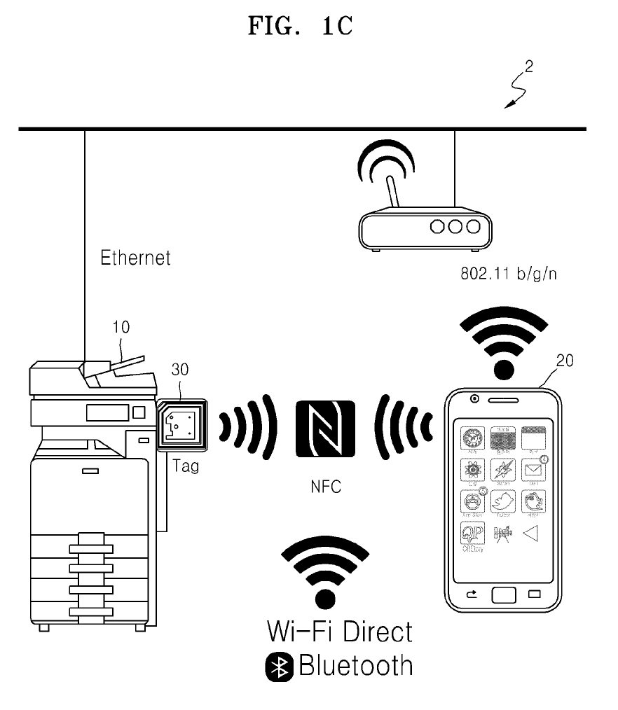

FIG. 1A illustrates a near field communication (NFC) environment 1 according to an exemplary embodiment of the present general inventive concept. Referring to FIG. 1A, an image forming apparatus 10 and a user device 20 (which may correspond to a smartphone) each supporting an NFC function are present in the NFC environment 1. An NFC tag 30 (illustrated in FIG. 1B) is embedded in the image forming apparatus 10 illustrated in FIG. 1A in advance, and thus communication between the image forming apparatus 10 and the smartphone 20 may be performed via NFC, as illustrated by the NFC logo.

FIG. 1B illustrates an NFC environment 1 which is similar to the NFC environment 1 illustrated in FIG. 1A, according to an exemplary embodiment of the present general inventive concept. Referring to FIG. 1B, an image forming apparatus 10 and a smartphone 20 each supporting an NFC function are also present in the NFC environment 1. In particular, an NFC tag 30 is embedded in advance in the image forming apparatus 10 of FIG. 1A, whereas no NFC tag 30 is embedded in the image forming apparatus 10 in FIG. 1B in advance. Accordingly, the image forming apparatus 10 of FIG. 1B may communicate with the smartphone 20 via NFC only when an NFC tag 30 is installed later in the image forming apparatus 10.

If an NFC tag 30 is installed later in the image forming apparatus 10 of FIG. 1B, then an operation of the NFC environment 1 illustrated in FIG. 1B is identical to that of the NFC environment 1 of FIG. 1A, in which the NFC tag 30 is embedded in advance.

While just one pair of devices, that is, the image forming apparatus 10 and the smartphone 20, is present in the NFC environment 1 for convenience of description, more electronic devices of different types that support an NFC function may also be present in the NFC environment 1. These devices may also operate in the same manner of NFC as in the current exemplary embodiment of the present general inventive concept.

FIG. 10 illustrates a wireless communication environment 2 in which an image forming apparatus 10 and a smartphone 20 are present, according to an exemplary embodiment of the present general inventive concept. Referring to FIG. 10, examples of other peripheral wired/wireless networks are illustrated in addition to the NFC environment 1 of FIG. 1A or 1B. The NFC environment 1 may operate in connection with peripheral wired/wireless networks, such as Wi-Fi Direct, Bluetooth, Ethernet, 802.11a/b/g/n, etc.

Before further describing the exemplary embodiments of the present general inventive concept in detail, NFC technology will be described.

In detail, NFC is a type of Radio Frequency Identification (RFID) wireless communication method in which data is directly exchanged between terminals, for example, between the image forming apparatus 10 and the smartphone 20, without using a communication network. A wireless communication method using RFID may be classified according to frequencies used. For example, RFID at 13.56 MHz is mainly used for smart cards, such as transit cards or entrance cards, and RFID at 900 MHz is used mainly for logistics. NFC corresponds to RFID which, like smartcards, uses a frequency of 13.56 MHz. However, unlike smartcards, which allow only one-way communication, NFC allows two-way communication. Accordingly, NFC is different from smart cards, which function merely as a tag that stores particular information and transmits the same to a reader. NFC allows a tag function according to necessity but also supports a function of recording information on the tag, and may be used in peer to peer (P2P) data exchange between terminals in which NFC is set.

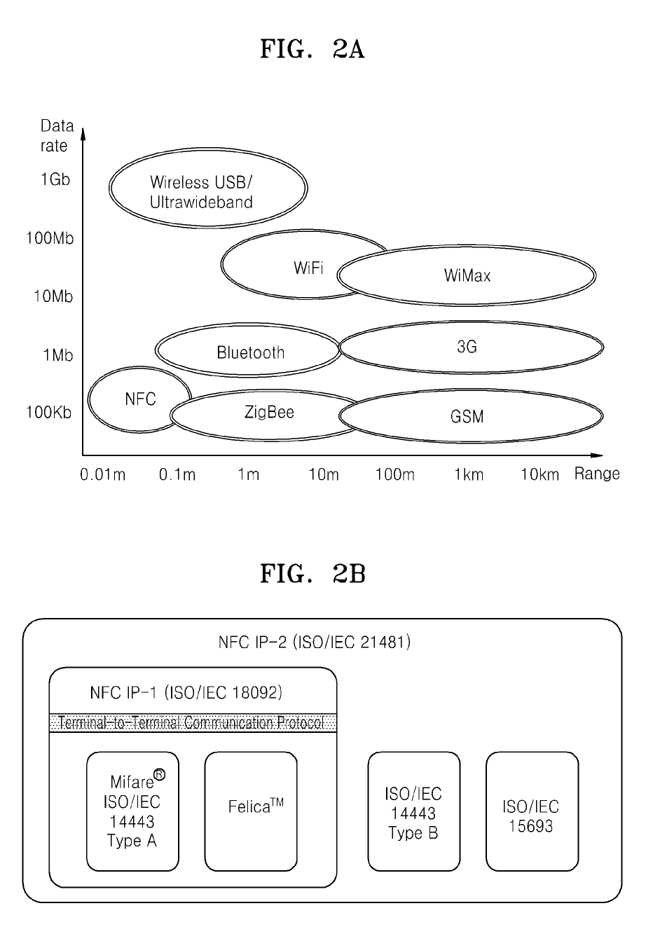

NFC which is developed based on RFID may be compared with other wireless communication methods, such as for example Wi-Fi Bluetooth, ZigBee, etc., as illustrated in FIG. 2A.

FIG. 2A is a graph comparing data rates and communication ranges of NFC and other wireless communication methods. Referring to FIG. 2A, NFC may operate at a distance within about 10 cm, unlike Bluetooth or Wi-Fi etc., which allow communication in about several to several tens of meters.

In addition to range, NFC may be compared to the security and service areas of other wireless communication methods, such as Bluetooth, ZigBee, etc., examples of which are shown in Table 1 below.

TABLE 1

| | Frequency | | | Standard | Major service |
|---|---|---|---|---|---|
| Technology | used | | security | range | area |
| NFC | 13.56 | MHz | Encryption | International | contactless |
| | | | is applied | Standard | payment, |
| | | | | | RFID, file |
| | | | | | transmission |
| Bluetooth | 2.4 | GHz | N/A | International | file |
| | | | | Standard | transmission |
| ZigBee | 2.4 | GHz | N/A | International | device control, |
| | | | | Standard | RFID |
| 900 MHz | 900 | MHz | N/A | Korean | RFID |
| RFID | | | standard | | |

In other words, compared to other wireless communication methods, NFC operates only within a distance of 10 cm and encryption technology is applied thereto, and thus, a security level of NFC is high. Accordingly, when used in combination with other high-speed wireless communication methods, such as 3G or Wi-Fi, communication between devices via NFC may be performed with a higher efficiency. For example, when NFC and Bluetooth technology are combined, NFC may be used in connecting terminals (authorization) and Bluetooth may be used in data transmission between the terminals to thereby enable more efficient communication between the devices.

FIG. 2B is an overview of standards related to NFC technology.

Referring to FIG. 2B, NFC standard technology follows International Organization for Standardization (ISO) and is also an extension of ISO 14443 Proximity-card Standard, and here, the inclusion relation of NFC IP-1(NFC Interface Protocol-1)(ISO/IEC 18092) and NFC IP-2(ISO/IEC 21481) is illustrated. Here, ISO/IEC 14443 Type A and Type B, FeliCa, and ISO/IEC 15693 are international standards of four areas of contactless cards operating at 13.56 MHz. Also, ISO/IEC 18092 defines communication modes for NFC interface and protocol.

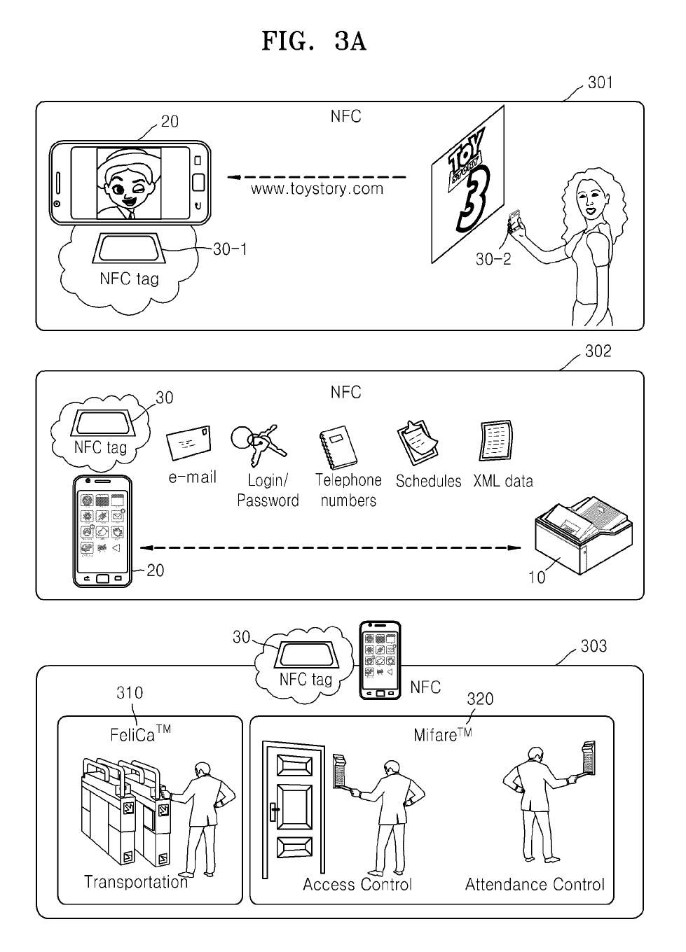

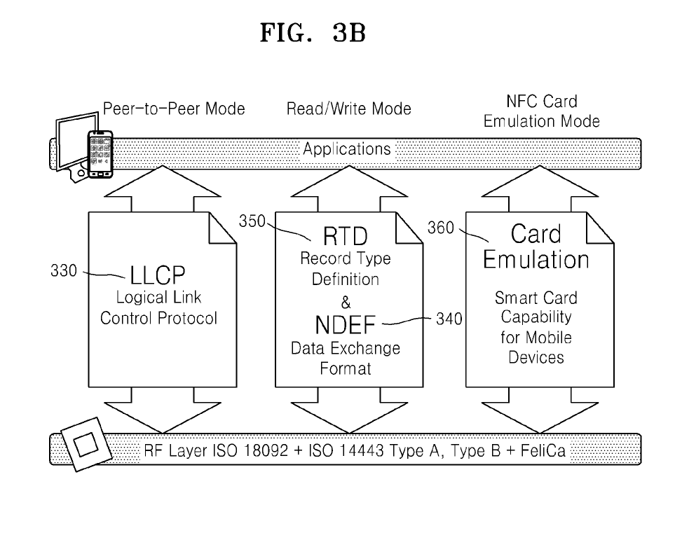

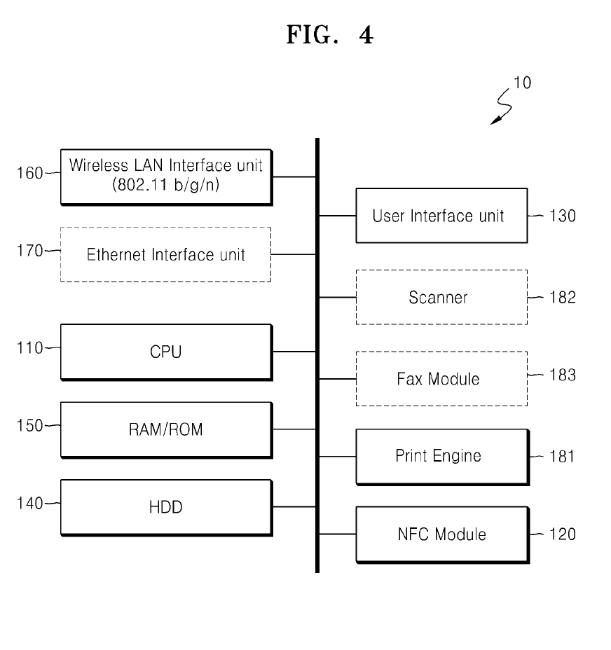

FIGS. 3A and 3B are diagrams illustrating three communication modes of NFC.

Referring to FIG. 3A, the NFC Forum has standardized major NFC communication modes, which are a Reader/Writer mode 301, a P2P mode 302, and a Card Emulation mode 303. In sum, the three communication modes of NFC may be listed as in Table 2 below.

TABLE 2

| | ISO/IEC 15693 | ISO/IEC 18092 | ISO/IEC 14443 |
|---|---|---|---|
| Operational mode | communication | communication | communication |
| | between reader | between devices | between reader |
| | and tag | (P2P mode) | and tag |
| | (VCD2 mode) | | (PCD1 mode) |
| Power supply | Manual | active and manual | manual |
| Range of | 1 m | 10-20 cm | 10 cm |
| communication | | | |
| Data rate | 26 Kbps or less | 106 Kbps, | 106 Kbps |
| | | 212 Kbps, 424 Kbps | |

(PCD: Proximity Coupling Device, VCD: Vicinity Coupling Device)

First, the Reader/Writer mode 301 supports the user device 20 (corresponding to a smart phone), in which a first NFC tag 30-1 is embedded, to operate as a reader to read an external NFC tag 30-2, as illustrated in the Figure. Alternatively, the smartphone 20 may operate as a writer to input information to the external NFC tag 30-2.

In the P2P mode 302, communication at a link level between two NFC terminals, for example, between the image forming apparatus 10 and the smartphone 20, is supported. To establish a connection, a client (NFC P2P initiator, the smartphone 20 in this exemplary embodiment) searches for a host (NFC P2P target, the image forming apparatus 10 in this exemplary embodiment) and transmits data of an NDEF message format. In the P2P mode 302, data, such as emails, login/password information, schedules, telephone numbers, and XML data, may be exchanged just by touching the image forming apparatus 10 with the smartphone 20.

Finally, in the Card Emulation mode 303, the smartphone 20, in which an NFC tag 30 is embedded, operates as a smart card (ISO/IEC 14443). Accordingly, NFC is compatible not only with ISO 14443, which is the international standard for contactless cards, but also with other wireless standards such as Felica 310 by SONY and MiFare 320 by PHILIPS, for example. This allows the smartphone 20 to be used for transportation, access control, and attendance control, for example, as illustrated in FIG. 3A.

In order to coordinate the three communication modes of NFC, a protocol is standardized as illustrated in FIG. 3B. Referring to FIG. 3B, a software structure in a NFC system is illustrated.

Logical Link Control Protocol (LLCP) 330 is a protocol that sets a communication connection between layers and controls the same. A NFC Data Exchange Format (NDEF) message 340 is a basic message structure defined in an NFC communication protocol. The NDEF is a standard exchange format for Uniform Resource Identifier (URI), smart posters, and others, which defines a recording format regarding message exchange between NFC Forum-compatible devices and tags. An NDEF message 340 includes at least one NDEF record. The NDEF record includes a payload that is described according to type, length, and option identifiers. An NDEF payload refers to application data included in an NDEF record. Record Type Definition (RTD) 350 defines a record type and a type name which may correspond to an NDEF record. Card emulation 360 defines smart card capability for mobile user devices such as the smartphone 20.

FIG. 4 is a block diagram illustrating a basic hardware structure of the image forming apparatus 10 supporting an NFC function, according to an exemplary embodiment of the present general inventive concept. Referring to FIG. 4, the image forming apparatus 10 may include a central processing unit (CPU) 110, an NFC module 120, a user interface unit 130, a hard disk drive (HDD) 140, a random access memory/read only memory (RAM/ROM) 150, a wireless local area network (WLAN) interface unit 160, an Ethernet interface unit 170, a print engine 181, a scanner 182, and a fax module 183.

The CPU 110 controls the overall operation of the image forming apparatus 10. Information needed to control the image forming apparatus 10, as well as print data, is stored in the HDD 140 and the RAM/ROM 150 and read therefrom by the CPU 110 when necessary.

The user interface unit 130 provides the user interface which the user interacts with when the user checks information of the image forming apparatus 10 and inputs a command to the image forming apparatus 10. The user interface unit 130 may be designed in various manners according to products; for example, it may be formed in a simple form of two or four lines on a display, such as a liquid crystal display (LCD) or light emitting diode (LED), or as a graphic user interface (GUI), so as to enable various graphical representations.

The WLAN interface unit 160 refers to hardware that performs IEEE 802.11b/g/n functionality, and may communicate with the image forming apparatus 10 via a universal serial bus (USB) or the like. The WLAN interface unit 160 may also support Wi-Fi Direct at the same time.

The Ethernet interface unit 170 refers to hardware that performs wired Ethernet communication according to IEEE 802.3. If the image forming apparatus 10 supports only WLAN, the Ethernet interface unit 170 may not be included, and so the Ethernet Interface Unit 170 is illustrated with a dotted line.

The print engine 181, the scanner 182, and the fax module 183 refer to hardware to perform a printing function, a scan function, and a fax function, respectively. The image forming apparatus does not necessarily need to support faxing, scanning, and printing, and unnecessary components need not be included. For example, if the image forming apparatus 10 is a printer, the scanner 182 and the fax module 183 may not be included. Accordingly, the Print Engine 181, Scanner 182, and Fax Module 183 are illustrated with dotted lines.

The image forming apparatus 10 includes the NFC module 120 to thereby communicate with other NFC devices, such as the smartphone 20, via NFC. The NFC module 120 is in charge of the NFC function and may read from or write data to an NFC tag 30. Also, communication with the main board of the image forming apparatus 10 is performed by using a Universal Asynchronous Receiver/Transmitter (UART), an Inter Integrated Circuit (12C), a Serial Peripheral Interface Bus (SPI), or the like. As described above with reference to FIGS. 1A and 1B, the NFC module 120 may be embedded in the image forming apparatus 10 in advance, or may be available once the user installs the NFC tag 30 later.

Although not shown in FIG. 4, the image forming apparatus 10 may also include other wireless communication modules, such as a Bluetooth module or a ZigBee module for example.

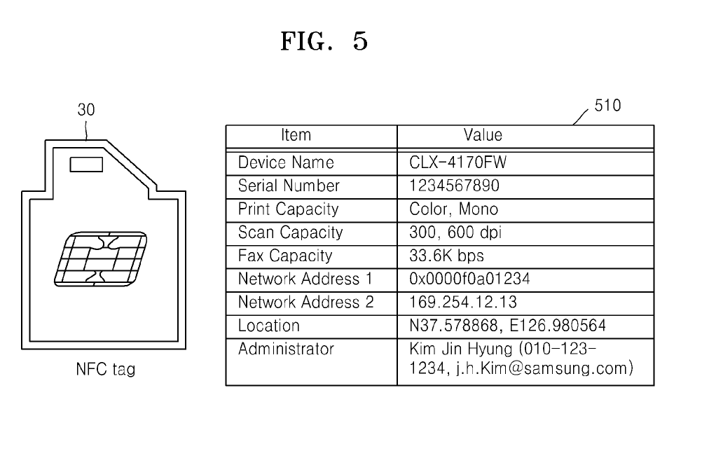

FIG. 5 illustrates an NFC tag 30 and information 510 which may be stored in the NFC tag 30 installed in the image forming apparatus 10 of FIG. 1B. Referring to FIG. 5, in the case of the image forming apparatus 10 of FIG. 1B, the NFC function may be utilized when the NFC tag 30 is inserted into a slot that is provided in advance in the image forming apparatus 10. The information 510 of the NFC tag 30, for example, performance information of the image forming apparatus 10, may be recorded by other NFC devices in the Reader/Writer mode 301 or may be stored in advance by a manager.

An image forming apparatus 60 supporting an NFC function according to an exemplary embodiment of the present general inventive concept and detailed functions and operations thereof and a method of performing authentication of an NFC device in the image forming apparatus 60 will be described in detail with reference to the drawings below.

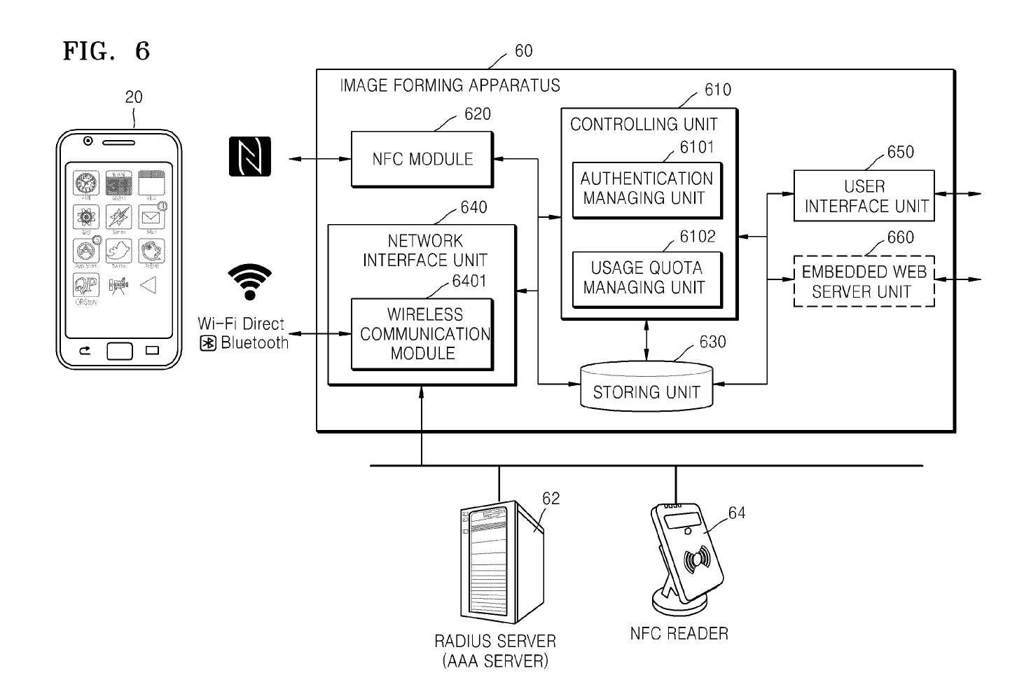

FIG. 6 is a block diagram illustrating a hardware structure of an image forming apparatus 60 that performs authentication of NFC devices by tagging a user device 20 that supports an NFC function, according to an exemplary embodiment of the present general inventive concept.

In FIG. 6, only hardware components related to the current exemplary embodiment of the present general inventive concept will be described in order to prevent obscuring the characteristics of the current exemplary embodiment. However, general-use hardware components other than the illustrated hardware components may also be included.

Further regarding FIG. 6, the image forming apparatus 60 is illustrated as including just hardware components related to the current exemplary embodiment from among the hardware components of the image forming apparatus 10 illustrated in FIG. 4. However, elements that are omitted in FIG. 6 but described with reference to the image forming apparatus 10 of FIG. 4 may also be included in the image forming apparatus 60.

The image forming apparatus 60 includes a controlling unit 610, an NFC module 620, a storing unit 630, a network interface unit 640, a user interface unit 650, and an embedded web server unit 660. The controlling unit 610 includes an authentication managing unit 6101 and a usage quota managing unit 6102, and the network interface unit 640 includes a wireless communication module 6401. In FIG. 6, the controlling unit 610 corresponds to the CPU 110 of FIG. 4, the NFC module 620 corresponds to the NFC module 120 of FIG. 4, the storing unit 630 corresponds to the HDD 140 of FIG. 4, and the user interface unit 650 corresponds to the user interface unit 130 of FIG. 4. Meanwhile, the wireless communication module 6401 refers to any hardware that uses wireless communication methods other than NFC, such as a Bluetooth module or a Zigbee module.

The NFC module 620 recognizes access of the user device 20 having an NFC function according to an NFC protocol. In order to activate the NFC function to set a connection, a predetermined NFC device corresponding to a client (the user device 20, which may correspond to the smartphone in this exemplary embodiment) is to approach another NFC device corresponding to a host (the image forming apparatus 60 in this exemplary embodiment) within a close range of 10 cm or less.

Accordingly, the NFC module 620 recognizes access of the user device 20 to tag the user device 20. As described above, as the NFC module 620 receives an NDEF message defined according to the NFC standards, from the user device 20, it also receives identification information of the user device 20 included in the NDEF message.

The identification information included in the NDEF message includes information that uniquely exists only in the user device 20 such as a media access control (MAC) address, an Internet protocol (IP) address, a phone number or a personal identification number (PIN).

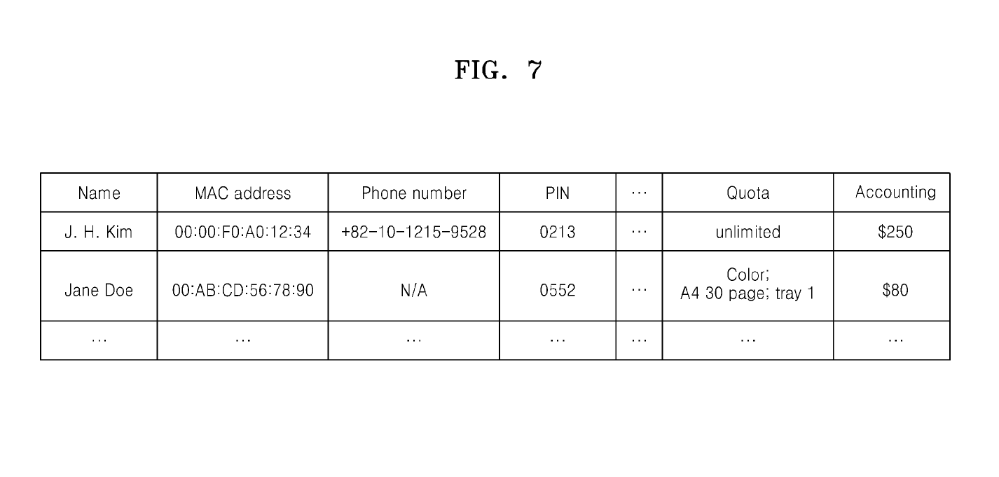

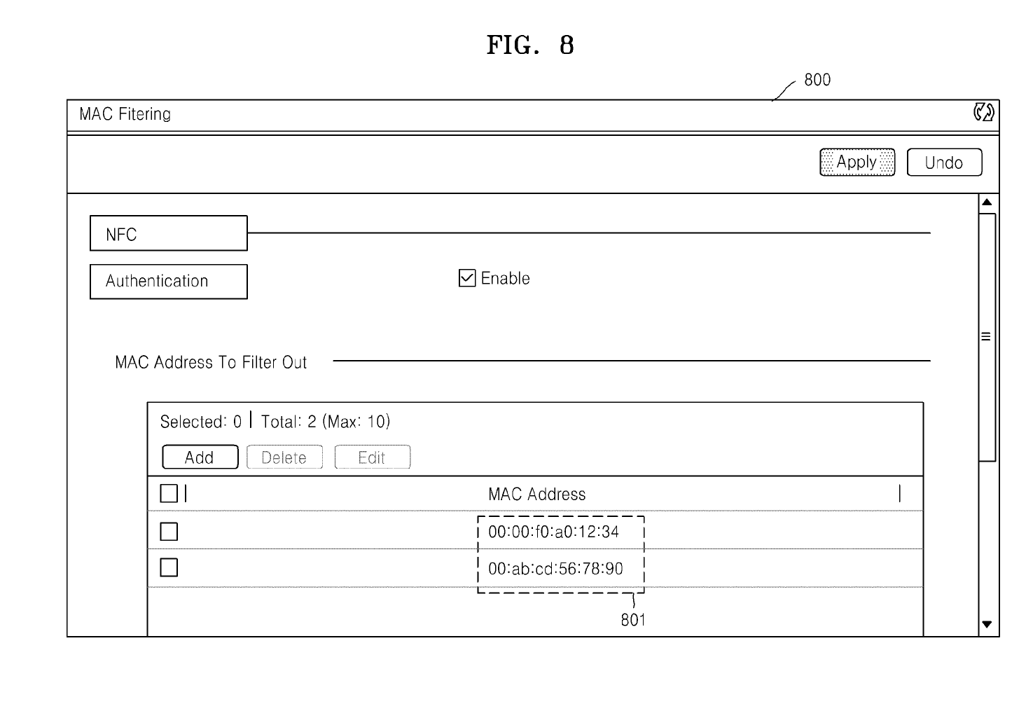

An authentication list 700 or 801 (illustrated in FIGS. 7 and 8) to manage a list of NFC devices, in regard to which the use of the image forming apparatus 60 related to the NFC function is authenticated, may preferably be stored in the storing unit 630 in advance before the controlling unit 610 determines whether the user device 20 is an authenticated device based on the identification information of the user device 20.

The storing unit 630 may store the authentication list 700 or 801 about authenticated NFC devices by using various methods.

For example, according to a first method, a user who wishes to use the image forming apparatus 60, or a manager of the image forming apparatus 60, may pay a fee for use of the image forming apparatus 60 or may input an employee identification number via a remote authentication dial in user service (RADIUS) server 62 that manages registration of the authentication list 700 or 801, thereby completing authentication of the user device 20 in advance. When authentication of the user device 20 is completed, authentication information, usage quota information or the like of the user device 20 is stored in the RADIUS server 62.

Here, the RADIUS server 62 is a server through which authentication, authorization, and accounting is performed, and is also called a AAA server.

The network interface unit 640 is a unit which is able to communicate with a network in a wired or wireless manner. The network interface unit 640 receives the authentication list 700 or 801 in which authentication information, usage quota information or the like of NFC devices is included, from the RADIUS server 62.

The storing unit 630 stores the authentication list 700 or 801 received from the RADIUS server 62 via the network interface unit 640.

Alternatively, according to a second method, a user who wishes to use the image forming apparatus 60 may pay a fee for use of the image forming apparatus 60, or may register the user device 20 by tagging the user device 20 on the NFC reader 64, thereby completing authentication of the user device 20 in advance. When authentication of the user device 20 is completed, authentication information, usage quota information, or the like of the user device 20 is stored in the NFC reader 64 or a server (not shown) that manages the NFC reader 64.

Here, the NFC reader 64 may be included near the image forming apparatus 60 for the purpose of accounting in regard to the use of the image forming apparatus 60, or alternatively may be located in a separate remote spot, but its location is not limited to one of these. Also, the NFC reader 64 may be a device connected to the RADIUS server 62 described above.

The network interface unit 640 receives the authentication list 700 or 801 including authentication information, usage quota information or the like of the NFC devices from the NFC reader 64.

The storing unit 630 stores the authentication list 700 or 801 received from the NFC reader 64 via the network interface unit 640.

FIG. 7 illustrates an authentication list 700 of NFC devices stored in the storing unit 630 according to an exemplary embodiment of the present general inventive concept.

Referring to FIG. 7, identification information, usage quota information, accounting information or the like about NFC devices such as a mobile phone of users (J. H. Kim, Jane Doe, etc.), in regard to which authentication is completed, are included in the authentication list 700. That is, as described above, the authentication list 700 may include for example usage quota and accounting information allocated with respect to use of the image forming apparatus 60 in addition to a MAC address, a phone number, and a PIN.

For example, while the user J. H. Kim may use all image forming functions of the image forming apparatus 60 without limitation, a limitation may be set for the user Jane Doe such that only color printing or color scanning is possible, and printing of only 30 sheets of A4 size paper and use of only one tray are allowed. As such, the authentication list 700 includes identification information, use quota information, accounting information or the like of NFC devices, and the information may be registered using the RADIUS server 62, the NFC reader 64, etc. as described above.

However, the authentication list 700 of FIG. 7 is merely an example, and the authentication list 700 may be modified to another form of table that may be managed.

Referring to FIG. 6 again, alternatively, according to a third method, a user who wishes to use the image forming apparatus 60 or a manager of the image forming apparatus 60 may register the authentication list 700 or 801 via the user interface unit 650.

That is, the user or manager of the image forming apparatus 60 may directly input or register the identification information, usage quota information or the like of NFC devices via the user interface unit 650, thereby completing authentication of the NFC devices. The registered information is stored in the storing unit 630.

Furthermore, alternatively, according to a fourth method, a user who wishes to use the image forming apparatus 60 or a manager of the image forming apparatus 60 may register the authentication list 700 or 801 via the embedded web server unit 660.

That is, the user or manager of the image forming apparatus 60 may directly input or register identification information, usage quota information or the like of NFC devices via the embedded web server unit 660 such as SyncThru Web Service® (SWS), thereby completing authentication of the NFC devices. Likewise, the registered information is stored in the storing unit 630.

Depending on the embodiment and the capabilities of the image forming apparatus 60, the embedded web server 660 may or may not be included. Accordingly, the embedded web server 660 is illustrated in FIG. 6 with a dotted line.

FIG. 8 illustrates a user interface (UI) screen 800 to input authentication data via the user interface unit 650 or the embedded web server unit 660, according to an exemplary embodiment of the present general inventive concept.

Referring to FIG. 8, a user or a manager of the image forming apparatus 60 may register identification information of NFC devices, for example, MAC addresses, in an authentication list 801, via the UI screen 800, thereby completing authentication of the NFC devices. However, the UI screen 800 of FIG. 8 is merely an example, and the UI screen 800 may be modified to a screen having another configuration.

As in the exemplary embodiments described above, an authentication list 700 or 801 including authentication information, identification information, usage quota information, accounting information or the like of NFC devices such as the user device 20 may be stored in the storing unit 630 in advance. However, similar methods of storing the authentication list 700 or 801 in the storing unit 630 in advance other than the above-described exemplary embodiments may also be available, and such other similar methods may also be included in exemplary embodiments of the present general inventive concept.

Referring to FIG. 6 again, the controlling unit 610 includes the authentication managing unit 6101 and the usage quota managing unit 6102 as described above. The controlling unit 610 may be a processor that is implemented with an array including a plurality of logic gates, or a general-use microprocessor. In other words, the controlling unit 610 may also be implemented by using various forms of hardware.

The controlling unit 610 determines whether the user device 20 is an authenticated device with regard to one or more image forming operations of the image forming apparatus 60 by using an NFC function, based on the identification information of the user device 20 received via the NFC module 620.

In detail, the authentication managing unit 6101 determines whether authentication information that is mapped to the identification information received from the user device 20 is present in the authentication list 700 or 801 stored in the storing unit 630 in advance. That is, the authentication managing unit 6101 determines whether the identification information of the user device 20 such as a MAC address or a phone number is present in the authentication list 700 illustrated in FIG. 7 or in the authentication list 801 illustrated in FIG. 8.

As a result of the determination of the authentication managing unit 6101, when identification information of the user device 20 is present in the authentication list 700 or 801 of the tagged user device 20, the tagged user device 20 is recognized as a legitimately authenticated device. However, if identification information of the user device is not present in the authentication list 700 or 801 of the tagged user device 20, the tagged user device 20 is recognized as an unauthenticated device and the use of the image forming apparatus 60 by using the NFC function is stopped. That is, the NFC connection between the image forming apparatus 60 and the user device 20 is ended.

The usage quota managing unit 6102 controls an image forming operation based on a usage quota allocated to the tagged user device 20 when it is determined that mapped authentication information exists in the identification information of the user device 20, that is, when authentication of the user device 20 is completed.

In detail, the controlling unit 610 does not activate the tagged user device 20 or the wireless communication module 6401 that transmits or receives working data about the tagged user device 20 and an image forming operation until the user device 20 is recognized as an authenticated device.

When the tagged user device 20 is recognized as an authenticated device, the wireless communication module 6401 may be activated such that contents to be operated on, such as pictures, schedules or documents stored in the user device 20, are transmitted by using another wireless communication method that is efficient in data transmission, instead of NFC. However, contents to be operated on are not necessarily received via the wireless communication module 6401. The contents to be operated on may instead be received via the NFC module 620.

The usage quota managing unit 6102 controls an image forming operation requested by the user device 20 such that the received contents such as pictures, schedules, or documents may be processed within the usage quota allocated to the user device 20. For example, when the user device 20 is an NFC device of the user Jane Doe illustrated in FIG. 7, the usage quota managing unit 6102 limits the requested image forming operation to color printing/scanning, printing of only 30 sheets of A4 size paper, and use of only one tray.

Furthermore, while an authentication list 700 or 801 is stored in the storing unit 630, when a new authentication list 700 or 801 registered by the RADIUS server 62, the NFC reader 64, the user interface unit 650, or the embedded web server unit 660 or the like is to be stored, the controlling unit 610 updates the storing unit 630 so that the new authentication list 700 or 801 may also be stored.

Meanwhile, examples of image forming operations supported by the image forming apparatus 60 are printing, scanning, photocopying, faxing, scan to mail, scan to server, scan to universal resource locator (URL), scan to personal computer (PC), scan to shared folder, and workflow. From among these functions, a mobile printing function of printing the contents received from the user device 20, in the image forming apparatus 60, and a mobile scan function of transmitting scan data generated by a scan function of the image forming apparatus 60 to the user device 20 will be described below.

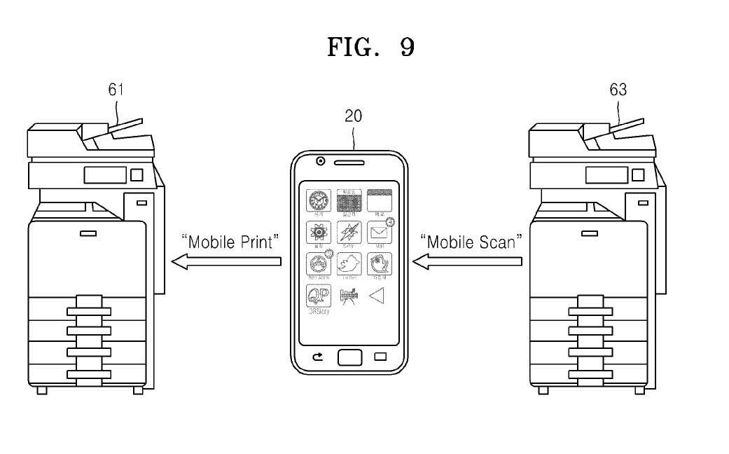

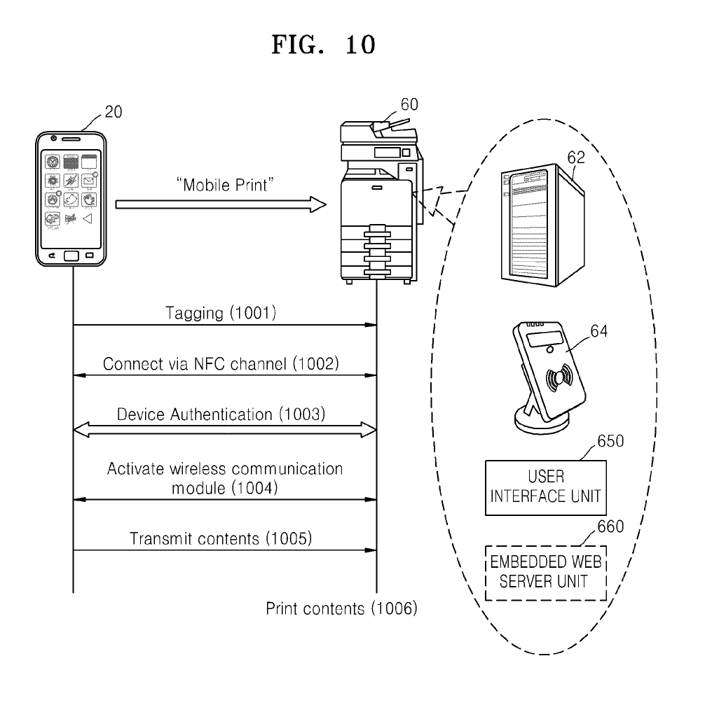

FIG. 9 is a schematic view illustrating a mobile printing function and a mobile scan function which may be performed between an image forming apparatus 61 or 63 and a user device 20, according to an exemplary embodiment of the present general inventive concept. The mobile printing function and the mobile scan function may be controlled by using the usage quota managing unit 6102, such that the mobile printing function and the mobile scan function are performed to an extent corresponding to a usage quota allocated to the user device 20. The image forming apparatus 61 or 63 corresponds to the image forming apparatus 60 illustrated in FIG. 6.

The mobile printing function illustrated in FIG. 9 is as follows: when authentication of the user device 20 tagged via the NFC function is completed, the image forming apparatus 61 performs a printing operation of contents such as pictures, schedules or documents received from the tagged user device 20.

The mobile scan function is as follows: when authentication of the user device 20 tagged via the NFC function is completed, scan data generated by a scanning operation in the image forming apparatus 63 is transmitted to the user device 20.

Here, the contents or scan data transmitted or received via the mobile printing function or the mobile scan function may be transmitted by using the NFC module 620 or the wireless communication module 6401 of the network interface unit 640.

Furthermore, although in the exemplary embodiment illustrated in FIG. 9, image forming apparatus 61 performs a mobile printing function and image forming apparatus 63 performs a mobile scan function, either image forming apparatus 61 and 63 may perform either of the mobile printing function and mobile scanning function. Additionally, although not illustrated in FIG. 9, when authentication of the user device 20 tagged by using the NFC function is completed, the image forming apparatuses 61 and 63 may also perform other image forming operations such as scan to email, scan to server, scan to URL, scan to PC, scan to shared folder, or the like.

The exemplary embodiments in which an authentication list 700 or 801 about the user device 20 is stored in the storing unit 630 in advance have been described above. However, alternatively, part of an image forming operation may be performed in advance, and then authentication of the user device 20 may be completed to finally finish the image forming operation (mobile printing or mobile scanning or the like).

In detail, while there is no authentication information of the user device 20 in the storing unit 630, the image forming apparatus 60 may generate print data according to a mobile printing function or scan data according to a mobile scan function and temporarily store them in the storing unit 630.

Then, when registration of authentication information of the user device 20 is completed by the RADIUS server 62, the NFC reader 64, the user interface unit 650, or the embedded web server unit 660, the authentication information is stored in the storing unit 630. In this operation, for example, when registration of the authentication information is completed, a PIN may be allocated to the user device 20.

When the storage of the authentication information is completed, the controlling unit 610 may control printing of the print data or transmission of the scan data to the user device 20. For example, in the case of allocating of a PIN described above, a PIN that is given by the controlling unit 610 so as to complete authentication may be directly input via the user interface unit 650. Accordingly, when authentication is completed, the controlling unit 610 may control completing of printing of the print data or transmission of scan data.

As described above, according to the current exemplary embodiment of the present general inventive concept, when an authentication list 700 or 801 about the user device 20 is stored in the storing unit 630 in advance or even when it is stored later, the image forming apparatus 60 may perform an image forming operation requested by the user device 20 by determining whether the user device 20 is authenticated or not.

FIG. 10 illustrates a mobile printing operation performed by authenticating a user device 20 in an image forming apparatus 60 according to an exemplary embodiment of the present general inventive concept.

Referring to FIG. 10, authentication information about the user device 20 registered by the RADIUS server 62, the NFC reader 64, the user interface unit 650 or the embedded web server unit 660 is stored in the storing unit 630 in advance.

In operation 1001, as the user device 20 approaches the image forming apparatus 60, the image forming apparatus 60 and the user device 20 are tagged via an NFC function.

In operation 1002, connection between the NFC module 620 of the image forming apparatus 60 and the user device 20 is set via an NFC channel. The NFC module 620 receives identification information of the user device 20 from the user device 20.

In operation 1003, the controlling unit 610 of the image forming apparatus 60 determines whether the user device 20 is an authenticated device with regard to one or more image forming operations of the image forming apparatus 60 by using an NFC function, based on the received identification information of the user device 20.

Here, the authentication managing unit 6101 of the controlling unit 610 determines whether authentication information mapped to the identification information of the user device 20 exists in the authentication list 700 or 801 stored in the storing unit 630.

In operation 1004, when it is determined that the user device 20 is an authenticated device, the controlling unit 610 activates the wireless communication module 6401 in order to receive contents such as pictures, schedules or documents from the user device 20. The wireless communication module 6401 corresponds to a module which is able to communicate in a wireless manner by, for example, Wi-Fi Direct or Bluetooth communication. However, the exemplary embodiments of the present general inventive concept are not limited thereto, and the image forming apparatus 60 may also receive contents via an NFC channel by using the NFC module 620.

In operation 1005, the user device 20 transmits the contents. Accordingly, the network interface unit 640 of the image forming apparatus 60, particularly, the wireless communication module 6401, receives the transmitted contents. Also, as described above, contents may also be received via the NFC module 620.

In operation 1006, the image forming apparatus 60 prints the received contents, thereby completing the mobile printing operation.

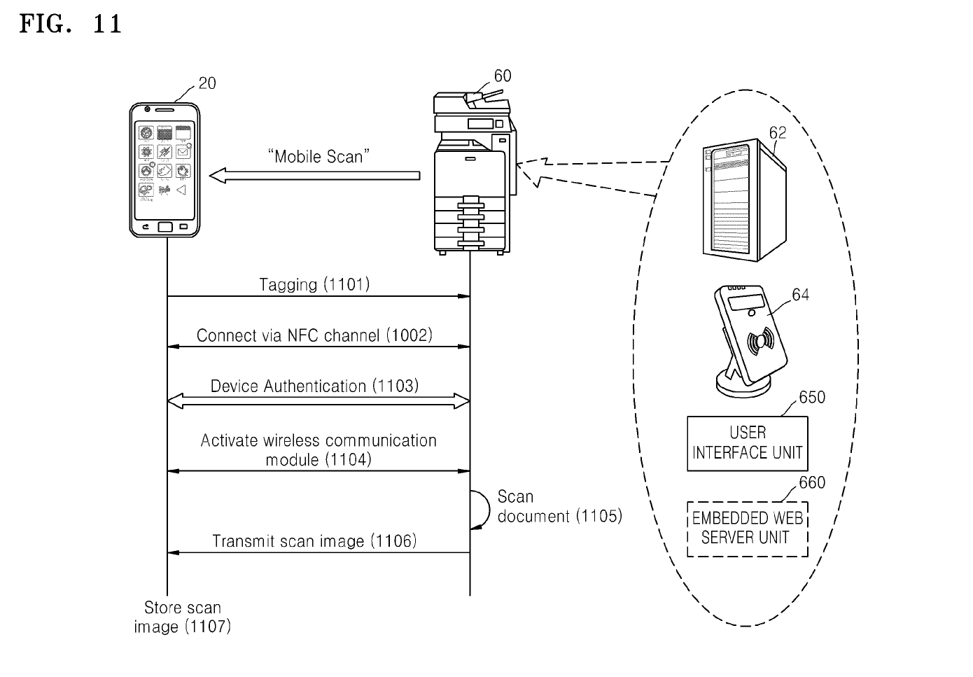

FIG. 11 illustrates a mobile scanning operation performed by authenticating a user device 20 in an image forming apparatus 60 according to an exemplary embodiment of the present general inventive concept.

Referring to FIG. 11, authentication information about the user device 20 registered by the RADIUS server 62, the NFC reader 64, the user interface unit 650 or the embedded web server unit 660 is stored in the storing unit 630 in advance.

In operation 1101, as the user device 20 approaches the image forming apparatus 60, the image forming apparatus 60 and the user device 20 are tagged via an NFC function.

In operation 1102, connection between the NFC module 620 of the image forming apparatus 60 and the user device 20 is set via an NFC channel. The NFC module 620 receives identification information of the user device 20 from the user device 20.

In operation 1103, the controlling unit 610 of the image forming apparatus 60 determines whether the user device 20 is an authenticated device with regard to one or more image forming operations of the image forming apparatus 60 by using an NFC function, based on the received identification information of the user device 20. Here, the authentication managing unit 6101 of the controlling unit 610 determines whether authentication information mapped to the identification information of the user device 20 exists in the authentication list 700 or 801 stored in the storing unit 630.

In operation 1104, when it is determined that the user device 20 is an authenticated device, the controlling unit 610 activates the wireless communication module 6401 in order to receive contents such as pictures, schedules or documents from the user device 20.

In operation 1105, the image forming apparatus 60 scans a document placed on the scanner 182 (illustrated in FIG. 4) to generate scan data or a scan image.

In operation 1106, the network interface unit 640 of the image forming apparatus 60, particularly, the wireless communication module 6401 transmits the generated scan image to the user device 20. Also, as described above, the scan image may be transmitted via the NFC module 620 instead of the wireless communication module.

In operation 1107, the user device 20 stores the received scan image, thereby completing the mobile scanning operation.

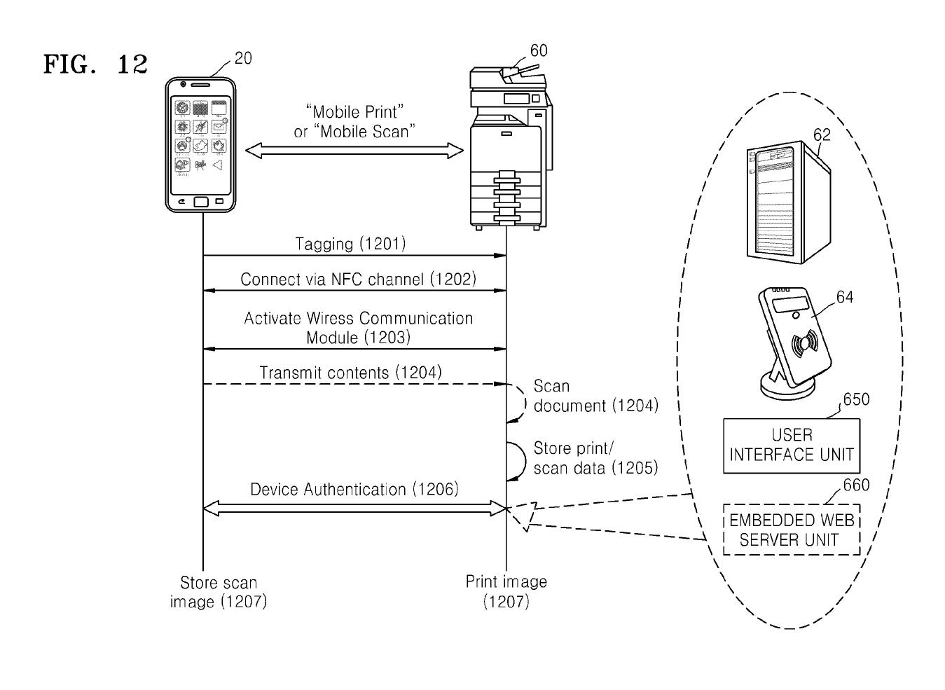

FIG. 12 illustrates an operation in which authentication of a user device 20 is completed after first generating print data or scan data in an image forming apparatus 60 and then a mobile printing operation or a mobile scanning operation is performed, according to an exemplary embodiment of the present general inventive concept.

Referring to FIG. 12, unlike FIGS. 10 and 11, authentication information about the user device 20 is not stored in the storing unit 630 in advance.

In operation 1201, as the user device 20 approaches the image forming apparatus 60, the image forming apparatus 60 and the user device 20 are tagged via an NFC function.

In operation 1202, connection between the NFC module 620 of the image forming apparatus 60 and the user device 20 is set via an NFC channel. The NFC module 620 receives identification information of the user device 20 from the user device 20.

In operation 1203, the controlling unit 610 activates the wireless communication module 6401.

In operation 1204, when a mobile printing operation is requested, the user device 20 transmits contents to the image forming device 60. Alternatively, when a mobile scanning operation is requested, the scanner 182 (illustrated in FIG. 4) scans a document.

In operation 1205, when a mobile printing operation is requested, the storing unit 630 temporarily stores print data about the contents transmitted in operation 1204. Alternatively, when a mobile scanning operation is requested, the storing unit 630 temporarily stores scan data about the document scanned in operation 1204.

In operation 1206, the storing unit 630 stores authentication information about the user device 20 registered by the RADIUS server 62, the NFC reader 64, the user interface unit 650 or the embedded web server unit 660.

Here, for example, a PIN for the user device 20 may be given.

In operation 1206, the controlling unit 610 determines whether the user device 20 is an authenticated device with regard to one or more image forming operations of the image forming apparatus 60 by using an NFC function, based on the received identification information of the user device 20. Here, the authentication managing unit 6101 of the controlling unit 610 determines whether authentication information mapped to the identification information of the user device 20 exists in the authentication list 700 or 801 stored in the storing unit 630.

Here, for example, the controlling unit 610 may determine whether authentication of the user device 20 is completed or not, by determining whether the PIN given to the user device 20 via the user interface unit 650 is input or not.

In operation 1207, when a mobile printing operation is requested, the image forming apparatus 60 prints the print data stored in the storing unit 630, thereby completing the mobile printing operation. Alternatively, when a mobile scanning operation is requested, the user device 20 receives scan data stored in the storing unit 630 and stores the received scan data, thereby completing the mobile scanning operation.

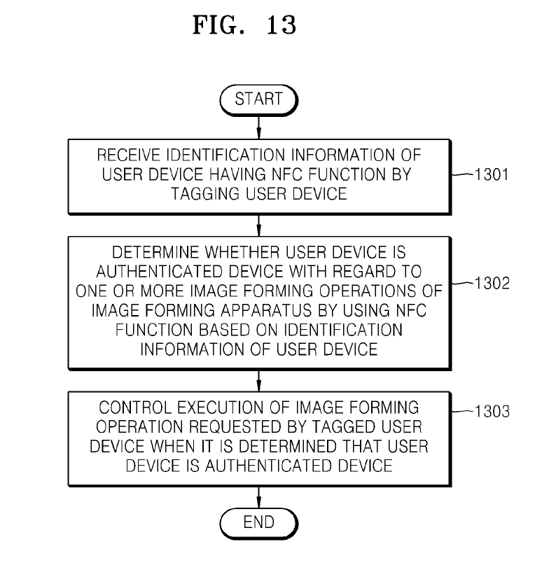

FIG. 13 is a flowchart illustrating a method of performing authentication of a user device 20 in an image forming apparatus 60 according to an exemplary embodiment of the present general inventive concept. Referring to FIG. 13, the method of performing authentication of the user device 20 includes operations that are processed in time-series in the image forming apparatus 60 illustrated in FIG. 6, and thus, details that are omitted below but are described above with reference to FIG. 6 may also be applied to the method illustrated in FIG. 13 of performing authentication of the user device 20.

In operation 1301, the NFC module 620 tags the user device 20 having an NFC function to receive identification information of the tagged user device 20.

In operation 1302, the controlling unit 610 determines whether the user device 20 is an authenticated device with regard to one or more image forming operations of the image forming apparatus 60 by using an NFC function, based on the received identification information of the user device 20.

In operation 1303, when the tagged user device 20 is determined as an authenticated device, the controlling unit 610 controls execution of an image forming operation requested by the tagged user device 20.

According to the exemplary embodiments of the present general inventive concept, the use of an image forming function in an image forming apparatus supporting an NFC function may be limited to only NFC devices whose authentication is completed. Accordingly, misuse of the image forming apparatus by unauthenticated NFC devices may be prevented.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a Blu-Ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus supporting a near field communication (NFC) function, the image forming apparatus comprising:
an NFC module to receive identification information of a user device having the NFC function by tagging the user device; and
a controlling unit to determine whether the tagged user device is an authenticated device with regard to one or more image forming operations of the image forming apparatus by using the NFC function, based on the received identification information,
wherein the controlling unit controls execution of one of the image forming operations when requested by the tagged user device, when the tagged user device is determined as an authenticated device with regard to the requested image forming operation.

2. The image forming apparatus of claim 1, further comprising:
a storing unit to store a first authentication list to manage a list of one or more NFC devices with regard to which of the one or more image forming operations of the image forming apparatus is authenticated for each of the NFC devices by using the NFC function,
wherein the controlling unit determines whether authentication information mapped to the received identification information exists in the stored first authentication list.

3. The image forming apparatus of claim 2, wherein the stored first authentication list comprises:
authentication information of each of the NFC devices; and
usage quota information of the image forming operations allocated to each of the NFC devices.

4. The image forming apparatus of claim 3, wherein the controlling unit comprises:
an authentication managing unit to determine whether authentication information mapped to the received identification information exists in the stored authentication information; and
a usage quota managing unit to control the execution of the requested image forming operation based on a usage quota allocated to the tagged user device when it is determined that the mapped authentication information exists.

5. The image forming apparatus of claim 1, further comprising:
a wireless communication module to transmit and receive working data about the tagged user device and the requested image forming operation,
wherein the controlling unit activates wireless communication between the tagged user device and the wireless communication module when it is determined that the tagged user device is an authenticated device with regard to the requested image forming operation.

6. The image forming apparatus of claim 2, further comprising:
a network interface unit to receive a second authentication list from a server that manages registration of at least one of authentication information and usage quota information of one or more NFC devices,
wherein the controlling unit controls updates of the first authentication list stored in the storing unit based on the received second authentication list.

7. The image forming apparatus of claim 6, wherein:
the network interface unit receives the second authentication list from at least one of a remote authentication dial in user service (RADIUS) server that performs authentication, authorization, and accounting of the NFC devices and an NFC reader that tags the NFC devices to manage registration of at least one of authentication information and usage quota information of the NFC devices.

8. The image forming apparatus of claim 2, further comprising:
a user interface unit that receives an input by a user or a manager regarding registration of at least one of authentication information and usage quota information of one or more NFC devices,
wherein the controlling unit controls updates of the first authentication list stored in the storing unit based on the received input.

9. The image forming apparatus of claim 2, further comprising:
an embedded web server unit to manage registration of information, the information comprising at least one of authentication information and usage quota information of one or more NFC devices,
wherein the controlling unit controls updates of the first authentication list stored in the storing unit based on the information registered in the embedded web server unit.

10. The image forming apparatus of claim 1, further comprising:
a storing unit to store working data generated by the requested image forming operation requested by the tagged user device while there is no authentication information about the tagged user device,
wherein the controlling unit controls completing of the requested image forming operation by using the stored working data when an operation of storing authentication information about the tagged user device in the storing unit is completed.

11. The image forming apparatus of claim 1, wherein:
the identification information comprises at least one of a media access control (MAC) address, an Internet protocol (IP) address, a phone number, and a personal identification number (PIN) of the user device.

12. The image forming apparatus of claim 1, wherein:
the controlling unit includes at least one of a mobile printing function of printing data received from the tagged user device and a mobile scan function of transmitting data generated by a scan function of the image forming apparatus to the tagged user device.

13. A method of performing authentication of near field communication (NFC) devices in an image forming apparatus supporting an NFC function, the method comprising:
receiving identification information of a user device having the NFC function by tagging the user device;
determining whether the tagged user device is an authenticated device with regard to one or more image forming operations of the image forming apparatus by using the NFC function, based on the received identification information; and
controlling execution of one of the image forming operations when requested by the tagged user device, when it is determined that the tagged user device is an authenticated device with regard to the requested image forming operation.

14. The method of claim 13, further comprising:
storing a first authentication list to manage a list of one or more NFC devices with regard to which of the one or more image forming operations of the image forming apparatus is authenticated for each of the NFC devices by using the NFC function,
wherein the determining comprises:
determining whether authentication information mapped to the received identification information exists in the stored first authentication list.

15. The method of claim 14, wherein the stored first authentication list comprises:
authentication information of each of the NFC devices; and
a usage quota of the image forming operations allocated to each of the NFC devices.

16. The method of claim 13, further comprising:
activating wireless communication between a wireless communication module and the tagged user device when it is determined that the tagged user device is an authenticated device with regard to the requested image forming operation.

17. The method of claim 14, further comprising:
receiving a second authentication list from a server that manages registration of at least one of authentication information and usage quota information of one or more NFC devices via a network interface unit; and
updating the stored first authentication list based on the received second authentication list.

18. The method of claim 14, further comprising:
receiving from a user or a manager an input regarding registration of at least one of authentication information and usage quota information of one or more NFC devices via at least one of a user interface unit and an embedded web server unit; and
updating the stored first authentication list based on the received input.

19. The method of claim 13, further comprising:
storing working data generated by the requested image forming operation requested by the tagged user device while there is no authentication information about the tagged user device,
wherein the controlling comprises:
controlling completing of the requested image forming operation by using the stored working data when an operation of storing authentication information about the tagged user device in the storing unit is completed.

20. A non-transitory computer-readable recording medium to contain computer-readable codes as a program to execute the method of claim 13.
